(19) United States
(12) Patent Application Publication
(10) Pub. No.: US 2008/0248252 A1
(43) Pub. Date: Oct. 9, 2008

(54) Piece Of Trim Having A Skin, And A Method Of Manufacturing It

(75) Inventor: Jonathan Cassaro, Paris (FR)

Correspondence Address: YOUNG & THOMPSON, 209 Madison Street, Suite 500, ALEXANDRIA, VA, 22314, US

(73) Assignee: FAURECIA INTERIEUR INDUSTRIE, Manterre (FR)

(21) Appl. No.: 12/064,667

(22) PCT Filed: Aug. 24, 2006
(86) PCT No.: PCT/FR2006/001977

§ 371 Date: Feb. 25, 2008

(30) Foreign Application Priority Data
Aug. 25, 2005 (FR) 0508752

(51) Int. Cl. B29C 44/16

(52) U.S. Cl. 428/158; 264/572

(57) ABSTRACT

The invention relates to a piece of trim comprising a visible skin (16), in which an edge part of the visible surface is positioned adjacent to a concealed surface part of a rigid support (10) and held in place by a plastic foam (20) that is disposed between the skin (16) and the support (10). The inventive piece of trim comprises a strip (22) of open-porosity material, which is placed essentially along the entire length of the edge (18) of the skin in contact at least partially with the edge part of the visible surface of the skin and with the concealed surface part of the support. The open-porosity material has a sufficient heat resistance such that, inside the finished piece, part of the material retains open porosity. The invention is suitable for pieces of trim for motor vehicles.

The present invention relates to pieces of trim, of the type that comprise a skin carried on a support with a layer of foam interposed between the trim and the support, and it also relates to a method of manufacturing such a piece of trim.

It is already known to make pieces of trim, in particular for motor vehicles, by a method that includes a step in which a foam of plastics material is injected between the skin and the support and pushes a marginal portion of the skin against a hidden inside surface of the support. The marginal portion of the skin is not fastened to the support, such that during the step of injecting the foam, gas can escape between the skin and the support so as to avoid forming voids in the piece of trim. However, when the injected foam front comes up to the edge of the skin, it pushes it against the support, thereby providing good retention and good sealing against passing the plastics material constituting the foam.

Thus, the co-operation between the marginal portion of the skin and the inside surface of the support performs two functions, firstly that of a vent for venting air, and secondly that of a sealing device for preventing a foam from passing.

When the skin is made of a plastics material, e.g. having elastomeric properties, it is possible to adjust the properties of the elements used very accurately so that both functions are performed in satisfactory manner. However, it would be desirable to broaden the ranges over which various parameters can be adjusted so as to make it easier to manufacture such pieces of trim.

In addition, when the skin is a natural material having properties that are variable, e.g. leather, it is difficult to obtain both functions from the marginal portion in a manner that is sufficiently repeatable to ensure that the defect rate is small, regardless of whether it is due to cavities being formed or to foam infiltrating.

Document JP-09 262 845 discloses a method of manufacturing pieces of trim in which a flexible sealing strip is placed between the inside face of the skin and an adjacent portion of the support that is perpendicular to the inside face of the skin. Under the action of the foam, the strip can take up a circularly arcuate shape between the inside face of the skin to which it is stuck and the surface of the support. It is stated that the strip can be formed by a foam having open cells that allow gas to pass but that retain the foam. That method makes it possible to obtain both of the above-mentioned functions, but it requires the sealing strip to be stuck to the inside face of the skin, i.e. the face opposite from its visible face.

An object of the invention is to make pieces of trim that enable both of the above-mentioned functions to be obtained even when the skin is made of a material having properties that can vary, e.g. when the skin is made of leather. Nevertheless, the method applies to skins of all types, insofar as it makes it possible to enlarge the ranges of physical conditions under which such pieces of trim can be manufactured.

According to the invention, the above object is achieved by placing a strip of material having open pores where the marginal portion of the skin co-operates with the opposing surface of the support, between said marginal portion and said surface. Under such conditions, there is no need for the strip to be held against the skin before manufacture by injecting foam. In contrast, it is advantageous for the strip to be held by the support, since manufacture can then be identical to manufacturing a piece without a strip of material having open pores, and holding devices of the kind described in the above-mentioned document JB-09 262 845 are not of any use.

More precisely, the invention relates to a piece of trim having a visible skin with a marginal portion of the visible face being adjacent to a hidden surface portion of a rigid support against which it is held by a foam of plastics material placed between the skin and the support; according to the invention, the piece of trim includes a strip of a material having open pores that is placed practically along the edge of the skin, in contact at least in part with the marginal portion of the visible face of the skin and with the hidden surface portion of the support.

Preferably, the material having open pores possesses sufficient ability to withstand high temperatures to ensure that at least a portion of the material conserves at least some of its open pores within the finished piece of trim.

Preferably, the plastics material of the foam disposed between the skin and the support penetrates at least in part into pores of the material having open pores constituting the strip.

In an embodiment, the material having open pores is a thermoplastic material, e.g. a polyolefin. In another embodiment, the material having open pores is a thermosetting material, such as a polyurethane, and the strip of material having open pores is formed by a rigid foam.

Preferably, the material of the skin is a material presenting properties that lack uniformity, e.g. leather.

The invention also relates to a method of manufacturing a piece of trim according to the preceding paragraphs, the method being of the type comprising introducing plastics material foam by injection between the skin and the support; according to the invention, the method comprises, before the step of introduction by injection, a step of fastening a strip of material having open pores to an element of the piece of trim close to the edge of the skin, the element being selected from a marginal portion of the visible face and a hidden surface portion of the support.

In an implementation, the strip of material having open pores is fastened at least in part to the support. In another implementation, the strip of material having open pores is fastened in part to the marginal portion of the visible face of the skin and projects in part from the edge.

Preferably, the method comprises, at the end of introducing the foam by injection between the skin and the support, penetration of the plastics material of the injected foam into the pores of the material having open pores.

Preferably, the material having open pores is a thermoplastic material, and at the end of the foam being introduced, the method includes flattening the strip of the material having open pores at least in part by means of the material of the foam injected between the skin and the support.

Other characteristics and advantages of the invention can be better understood on reading the following description of embodiments, made with reference to the accompanying drawing, in which:

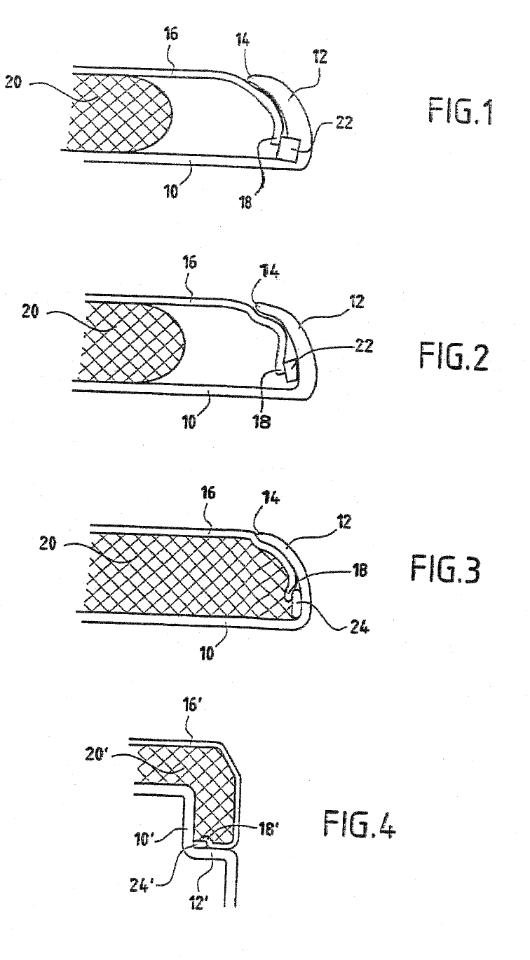

FIG. 1 shows a step in manufacturing a piece of trim of the invention;

FIG. 2 shows a step of manufacturing another piece of trim of the invention;

FIG. 3 shows the final disposition of the piece of trim obtained by implementing the method shown in FIG. 2; and

FIG. 4 shows the final disposition of another piece of trim obtained by implementing the method of the invention.

The description begins with the conventional method of manufacturing pieces of trim presenting a skin and a support that are spaced apart by a layer of plastics material foam. By means of its bottom and a reentrant side wall 12, the rigid support 10 defines a cavity that is to be closed by a flexible skin 16 having a marginal portion that penetrates into the cavity at an edge 14 of the support. The edge 18 of the skin is inserted well in towards the bottom of the cavity so that a considerable marginal portion of the skin is adjacent to the side wall 12 of the support.

When a plastic material foam 20 is injected between the support 10 and the skin 16, it expels the air lying ahead of it, so the air must be capable of escaping between the marginal portion of the skin and the side wall 12 of the support. In contrast, when the front of the foam 20 reaches the marginal portion of the skin, it is necessary for the skin to be pressed against the side wall 12 of the support so that the plastics material foam cannot infiltrate between the marginal portion of the skin and the side wall 12.

Thus, the co-operation between the marginal portion of the skin 16 and the side wall 12 of the support has two functions, the function of a vent device enabling the air expelled by the foam to be vented, and the function of a sealing device preventing the foam-forming fluid plastics material from passing.

According to the invention, even when the skin 16 has varying properties, e.g. being constituted by leather, these two functions can be obtained in a manner that is reproducible, i.e. from one piece of trim to another, by incorporating a strip of material having open pores at the edge 18 of the skin.

In FIG. 1, a strip 22 of material having open pores is, held against the support 10 level with the edge 18 of the skin 16 by being inserted in a groove or by being adhesively bonded to the rigid support 10.

While the foam 20 is being injected, the air can escape easily through the open pores of the strip 22, even when the edge 18 of the skin is pressed against the strip 22 of said material. When the plastics material of the foam reaches the strip 22, it begins to fill the pores therein. If the head loss created through the strip 22 is high enough, the plastics material of the foam cannot pass through the strip of foam, such that the marginal portion of the skin 16 is indeed pressed against the side wall 12 of the support.

Even if the head loss created by the strip 22 of material having open pores is not sufficient to prevent the plastics material of the foam from passing through, the pressure difference created through the strip 22 ensures that the marginal portion of the skin 16 is pressed against the side wall 12 by the foam 20 which is free to exert this pressure against the marginal portion. Thus, regardless of the properties of the strip 22, the marginal portion of the skin is always well pressed against the side wall 12 of the support.

In the embodiment of FIG. 2, the strip 22 of material having open pores is fastened to the edge of the skin in such a manner as to project beyond it. Even if the strip 22 is remote from the support, as soon as the plastics material of the foam 20 comes into contact with the strip 22, which is very light in weight, it moves it against the support so that the only potential passage for the foam of the layer 20 is to pass through the strip 22 of material having open pores. Consequently, as in FIG. 1, the marginal portion of the skin 16 is well pressed against the side wall 12 of the rigid support before the plastics material of the foam 20 can pass through the strip 22 of material having open pores.

FIG. 3 shows the appearance that can be obtained in the finished piece. As shown in FIG. 3, the material a having open pores is flexible, and it is partially flattened and partially filled with the material of the foam 20, and the entire marginal portion of the skin 16 is indeed pressed against the side wall 12 of the rigid support, with the exception of the extreme edge 18 that is fastened to the now-flattened strip of material having open pores, as referenced 24, which strip is also partially filled with the material of the layer of foam 20.

Compared with the conventional method of manufacturing such pieces of trim, the invention merely requires the strip 22 of material having open pores to be placed against the rigid support 20 or against the edge 18 of the skin.

FIG. 4 shows a variant piece of trim of the invention in which references analogous to those of FIGS. 1 to 3 are used again, followed by the prime symbol ′.

In this figure, as in the preceding embodiment, the marginal portion of the skin 16′ is well pressed by the foam 20′ against the side wall 12′ of the rigid support 10′, with the exception of the extreme edge 18′ that is fastened to the strip 24′ of material having open pores.

The principle on which the strip of material having open pores operates is to pass gas, i.e. the air expelled during injection of the foam, and to stop liquid materials. These two functions can be obtained equally well with rigid foams and with flexible foams. The only property that the strip 22 of material having open pores needs to possess is that, while the foam 20 is being injected, it allows the volume of air displaced by the foam to pass. Nearly all foams having open pores with a porosity of not less than 50% satisfy this condition, which is therefore not very constraining.

The chemical nature of the material having open pores constituting the strip 22 is not of great importance insofar as even if chemical reaction does take place between said material and the plastics material of the foam 20, such reaction is very limited since it takes place only at the end of the injection operation and lasts for a short time only before the piece cools down.

By way of example, the strip of foam maybe a strip of polyurethane or polyethylene foam, presenting density lying in the range 20 kilograms per cubic meter (kg/m³) to 180 kg/m³.

Given that the conditions relating to porosity are not very constricting, it is even possible to make use of other materials having open pores, and in particular felts.

Thus, the invention makes it possible to obtain good sealing of a skin, in particular made of leather, against a rigid support, while nevertheless ensuring proper evacuation of air while the foam is being injected.

Although the skin may be of any type, the invention is particularly useful when the skin is constituted by leather, this material of natural origin presenting problems that are specific thereto because of its lack of uniformity concerning certain properties, such as its thickness, flexibility, texture, etc., or when made of other materials presenting similar difficulties, such as composite materials in which one of the elements is a natural substance.

1-12. (canceled)

13. A piece of trim having a visible skin with a marginal portion of the visible face being adjacent to a hidden surface portion of a rigid support against which it is held by a foam of plastics material placed between the skin and the support, the piece of trim including a strip of a material having open pores that is placed practically along the edge of the skin, in contact at least in part with the marginal portion of the visible face of the skin and with the hidden surface portion of the support.

14. A piece according to claim 13, wherein the material having open pores possesses sufficient ability to withstand high temperatures to ensure that at least a portion of the material conserves at least some of its open pores within the finished piece of trim.

15. A piece according to claim 13, wherein the plastics material of the foam disposed between the skin and the support penetrates at least in part into pores of the material having open pores constituting the strip.

16. A piece according to claim 13, wherein the material having open pores is a thermoplastic material.

17. A piece according to claim 13, wherein the material having open pores is a thermosetting material, and the strip of material having open pores is formed by a rigid foam.

18. A piece according to claim 13, wherein the material of the skin is a material presenting properties that lack uniformity.

19. A piece according to claim 18, wherein the material of the skin is leather.

20. A method of manufacturing a piece of trim according to claim 13, the method being of the type comprising introducing plastics material foam by injection between the skin and the support, the method comprising, before the step of introduction by injection, a step of fastening a strip of material having open pores to an element of the piece of trim close to the edge of the skin, the element being selected from a marginal portion of the visible face and a hidden surface portion of the support.

21. A method according to claim 20, wherein the strip of material having open pores is fastened at least in part to the support.

22. A method according to claim 20, wherein the strip of material having open pores is fastened in part to the marginal portion of the visible face of the skin and projects in part from the edge.

23. A method according to claim 20, including, at the end of introducing the foam by injection between the skin and the support, penetration of the plastics material of the injected foam into the pores of the material having open pores.

24. A method according to claim 20, wherein the material having open pores is a thermoplastic material, and at the end of the foam being introduced, the method includes flattening the strip of the material having open pores at least in part by means of the material of the foam injected between the skin and the support.
